(19) United States
(12) Patent Application Publication
(10) Pub. No.: US 2025/0112950 A1
(43) Pub. Date: Apr. 3, 2025

(54) RISK SCORE ASSESSMENT BY A MACHINE LEARNING MODEL

(71) Applicant: Okta, Inc., San Francisco, CA (US)

(72) Inventors: Tanvir Islam, Lake Stevens, WA (US); Vinayak Shenoy, Seattle, WA (US); Christopher Joseph Camisa, Brooklyn, NY (US); RaghuRam Pamidimarri, Union City, CA (US); Gil Eliahu Popover, Natick, MA (US); Jinlong Fu, Oakville (CA)

(21) Appl. No.: 18/479,796

(22) Filed: Oct. 2, 2023

(51) Int. Cl. H04L 9/40

(52) U.S. Cl. CPC H04L 63/1433; H04L 63/08

(57) ABSTRACT

An identity management system may perform continuous risk scoring for session hijacking prevention. The identity management system identifies a pattern associated with a user account of the identity management system, where the pattern is identified using at least a risk assessment model. The pattern may be based on a set of attributes of the user account, the set of attributes obtained at the identity management system over a duration. The identity management system may receive a first request for the user account, the first request being associated with one or more first attributes. The identity management system may determine, using the risk assessment model, a risk score based on a first difference between the one or more first attributes and the pattern. The identity management system may respond to the first request based on whether the risk score satisfies a threshold.

### FIELD OF TECHNOLOGY

The present disclosure relates generally to identity management, and more specifically to risk score assessment by a machine learning model.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

An identity management system may receive login requests, in-session requests, or both for a user account. In some cases, the identity management system may determine a risk score after login, perform remediation after a session, or both. However, the identity management system may not be enabled to perform in-line remediation to prevent in-session threats.

### SUMMARY

The described techniques relate to improved methods, systems, devices, and apparatuses that support risk score assessment by a machine learning model. For example, such techniques may provide a framework for continuously evaluating a risk score based on receiving requests for a user account pre-authentication, post-authentication, or both. For example, the provided techniques provide for identifying, at a first device of an identity management system, a pattern associated with a user account of the identity management system using a risk assessment model. The risk assessment model may identify the pattern based on multiple attributes of the user account collected by the identity management system over a duration. For example, the identity management system may obtain the multiple attributes via digital signals associated with interactions between the user account and applications associated with the identity management system, via data signals from an authenticator application of a device associated with the user account, or both. The risk assessment model may determine the risk score based on the identity management system receiving requests for the user account. For example, the risk assessment model may determine the risk score based on the identity management system receiving a login request, receiving an in-session request, or both, from a second device (e.g., via an application programming interface (API)). The requests may be associated with one or more attributes. The risk assessment model may determine the risk score based on a difference between the one or more attributes and the pattern. The risk assessment model may determine the risk score based on positive and negative sampling, where the identity management system may input a first set of attributes associated with a first class and a second set of attributes associated with a second class such that the risk assessment model may identify differences between the first set of attributes and the second set of attributes. The identity management system may perform in-line remediation based on identifying the risk scores both pre-authentication and post-authentication.

A method by an apparatus for assessing risk associated with users of an identity management system is described. The method may include identifying, at a first device of the identity management system, a pattern associated with a user account of the identity management system, where the pattern is identified using at least a risk assessment model, and where the pattern is based on a set of multiple attributes of the user account obtained at the identity management system over a duration, receiving, from a second device via an API, a first request for the user account, the first request being associated with one or more first attributes, determining, at the first device using the risk assessment model, a risk score based on a first difference between the one or more first attributes and the pattern, and responding to the first request based on whether the risk score satisfies a threshold.

An apparatus for assessing risk associated with users of an identity management system is described. The apparatus may include one or more memories storing processor executable code, and one or more processors coupled with the one or more memories. The one or more processors may individually or collectively operable to execute the code to cause the apparatus to identify, at a first device of an identity management system, a pattern associated with a user account of the identity management system, where the pattern is identified using at least a risk assessment model, and where the pattern is based on a set of multiple attributes of the user account obtained at the identity management system over a duration, receive, from a second device via an API, a first request for the user account, the first request being associated with one or more first attributes, determine, at the first device using the risk assessment model, a risk score based on a first difference between the one or more first attributes and the pattern, and respond to the first request based on whether the risk score satisfies a threshold.

Another apparatus for assessing risk associated with users of an identity management system is described. The apparatus may include means for identifying, at a first device of an identity management system, a pattern associated with a user account of the identity management system, where the pattern is identified using at least a risk assessment model, and where the pattern is based on a set of multiple attributes of the user account obtained at the identity management system over a duration, means for receiving, from a second device via an API, a first request for the user account, the first request being associated with one or more first attributes, means for determining, at the first device using the risk assessment model, a risk score based on a first difference between the one or more first attributes and the pattern, and means for responding to the first request based on whether the risk score satisfies a threshold.

A non-transitory computer-readable medium storing code is described. The code may include instructions executable by a processor to identify, at a first device of an identity management system, a pattern associated with a user account of the identity management system, where the pattern is identified using at least a risk assessment model, and where the pattern is based on a set of multiple attributes of the user account obtained at the identity management system over a duration, receive, from a second device via an API, a first request for the user account, the first request being associated with one or more first attributes, determine, at the first device using the risk assessment model, a risk score based on a first difference between the one or more first attributes and the pattern, and respond to the first request based on whether the risk score satisfies a threshold.

Some examples of the method, apparatus, and non-transitory computer-readable medium described herein may further include operations, features, means, or instructions for training the risk assessment model to categorize requests into a first class associated with a first type of attribute or a second class associated with a second type of attribute, the second type of attribute being associated with lower risk than the first type of attribute.

In some examples of the method, apparatus, and non-transitory computer-readable medium described herein, training the risk assessment model may include operations, features, means, or instructions for inputting, to the risk assessment model, a first set of attributes of the set of multiple attributes, the first set of attributes being associated with the first class and inputting, to the risk assessment model, a second set of attributes of the set of multiple attributes, the second set of attributes being associated with the second class, where determining the risk score may be based on one or more differences between the first set of attributes and the second set of attributes.

In some examples of the method, apparatus, and non-transitory computer-readable medium described herein, the risk assessment model includes a gradient boosting machine (GBM) algorithm.

In some examples of the method, apparatus, and non-transitory computer-readable medium described herein, receiving the first request may include operations, features, means, or instructions for receiving an authentication request for access to the user account and determining the risk score in response to receiving the authentication request.

Some examples of the method, apparatus, and non-transitory computer-readable medium described herein may further include operations, features, means, or instructions for establishing a session for the user account with the identity management system in accordance with the response to the first request, receiving, during the session, one or more second requests for the user account, the one or more second requests being associated with one or more second attributes, determining, via the risk assessment model in response to the one or more second requests, a second risk score based on a second difference between the one or more second attributes and the pattern, and responding to the one or more second requests based on whether the second risk score satisfies the threshold.

Some examples of the method, apparatus, and non-transitory computer-readable medium described herein may further include operations, features, means, or instructions for triggering a multi-factor authentication (MFA) request for the user account based on the second risk score satisfying the threshold, where the response to the one or more second requests may be based on whether the MFA request may be successful, where second request may be an in-session request.

Some examples of the method, apparatus, and non-transitory computer-readable medium described herein may further include operations, features, means, or instructions for performing an adjustment to the pattern, where the adjustment may be based on whether the MFA request may be successful.

Some examples of the method, apparatus, and non-transitory computer-readable medium described herein may further include operations, features, means, or instructions for triggering a MFA request for the user account based on the first risk score satisfying the threshold, where the response to the first request may be based on whether the MFA request may be successful, where the first request may be a login request.

Some examples of the method, apparatus, and non-transitory computer-readable medium described herein may further include operations, features, means, or instructions for performing an adjustment to the pattern, where the adjustment may be based on whether the MFA request may be successful.

In some examples of the method, apparatus, and non-transitory computer-readable medium described herein, risk scores associated with subsequent requests may be based on the adjusted pattern.

In some examples of the method, apparatus, and non-transitory computer-readable medium described herein, the one or more first attributes include an internet protocol (IP) address associated with a source of the first request, a type of device associated with the source of the first request, a browser associated with the source of the first request, an operating system of a device associated with the source of the first request, a geographic location associated with the source of the first request, an identifier of the device associated with the source of the first request, or a managed state of the device associated with the source of the first request, or any combination thereof.

Some examples of the method, apparatus, and non-transitory computer-readable medium described herein may further include operations, features, means, or instructions for obtaining at least one attribute of the set of multiple attributes based on a data signal associated with one or more interactions between the user account and one or more applications associated with the identity management system.

Some examples of the method, apparatus, and non-transitory computer-readable medium described herein may further include operations, features, means, or instructions for obtaining at least one attribute of the set of multiple attributes based on a data signal from an authenticator application of a device associated with the user account, where the authenticator application may be associated with the identity management system.

### BRIEF DESCRIPTION OF THE DRAWINGS

FIG. 1 illustrates an example of a computing system that supports risk score assessment by a machine learning model in accordance with aspects of the present disclosure.

FIGS. 2 and 3 shows an example of a flowchart that supports risk score assessment by a machine learning model in accordance with aspects of the present disclosure.

FIG. 4 shows an example of a process flow that supports risk score assessment by a machine learning model in accordance with aspects of the present disclosure.

FIG. 5 shows a block diagram of an apparatus that supports risk score assessment by a machine learning model in accordance with aspects of the present disclosure.

FIG. 6 shows a block diagram of an identity management system that supports risk score assessment by a machine learning model in accordance with aspects of the present disclosure.

FIG. 7 shows a diagram of a system including a device that supports risk score assessment by a machine learning model in accordance with aspects of the present disclosure.

FIGS. 8 and 9 show flowcharts illustrating methods that support risk score assessment by a machine learning model in accordance with aspects of the present disclosure.

### DETAILED DESCRIPTION

In some examples, an identity management system may receive multiple requests for a user account. For example, the identity management system may receive login requests, in-session requests, or both. The identity management system may assess risk and perform multi-factor authentication (MFA) upon receiving login requests to confirm the identity of a user transmitting the request. However, the identity management system may respond to multiple requests during a session (e.g., post-authentication). In some cases, the identity management system may respond to in-session requests without assessing risk. As such, the identity management system may experience decreased security while responding to requests for the user account in-session. Additionally, risk assessment methods may involve different machine learning models. For example, the identity management system may use a neural network-based machine learning model to assess risk. However, the neural network-based machine learning model may be associated with an extensive deployment effort and high latency.

Various aspects of the present disclosure relate to continuous risk assessment via a machine learning model, and, more specifically, to continuously evaluating risk based on receiving both login requests and in-session requests. For example, the identity management system may train a risk assessment model to produce risk scores according to attributes associated with received requests. The identity management system may obtain parameters associated with a user account and compare the parameters, via the risk assessment model, to the attributes associated with a request to access the user account. For example, the risk assessment model may determine a risk score based on a difference between the attributes associated with the request and the parameters associated with the user account. The identity management system may determine the risk score based on receiving in-session requests, maintaining secure access to information associated with the user account. The risk score may correspond to a likelihood of a user account being associated with risk (e.g., fraudulent use). That is, a relatively high risk score may correspond to an account with a relatively high likelihood of fraudulent use. Accordingly, the identity management system may continuously monitor the risk score to prevent in-session hijacking.

The identity management system may train the risk assessment model via positive and negative sampling. For example, the identity management system may input a first set of attributes associated with a positive class and a second set of attributes associated with a negative class. The risk assessment model, based on the first set of attributes and the second set of attributes, may establish a threshold (e.g., boundary) separating high risk attributes and low risk attributes. Additionally, the risk assessment model may be an example of a gradient boosting machine (GBM) algorithm. For example, The GBM algorithm may classify the attributes associated with the request into a high risk class (e.g., attributes with a relatively high likelihood of being associated with fraudulent use) or a low risk class (e.g., attributes with a relatively low likelihood of being associated with fraudulent use) based on the training. The GBM may be associated with a less extensive deployment effort and low latency (e.g., compared to the neural network-based risk assessment model, where the neural network-based risk assessment model is associated with embeddings and comparison of the embeddings).

Aspects of the disclosure are initially described in the context of a computing system. Aspects of the disclosure are further described in the context of flowcharts and process flows. Aspects of the disclosure are further illustrated by and described with reference to apparatus diagrams, system diagrams, and flowcharts that relate to risk score assessment by a machine learning model.

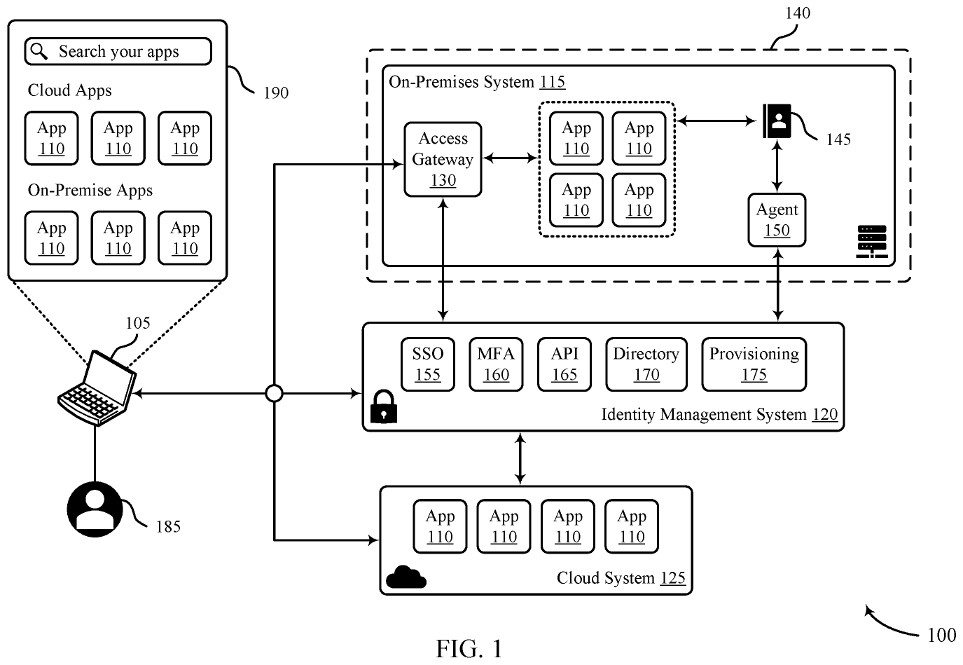

FIG. 1 illustrates an example of a computing system 100 that supports risk score assessment by a machine learning model in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a MFA service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

A user 185 may request to access a user account associated with the identity management system 120. For example, the user 185, via the computing device 105, may transmit one or more requests to the identity management system 120 to access the user account, the one or more requests including log-in requests, in-session requests, or both. The identity management system 120 may determine a risk score based on receiving the one or more requests. For example, the identity management system 120 may be associated with a risk assessment model trained to classify (e.g., into a low risk class or a high risk class) attributes associated with the one or more requests. As an illustrative example, a trusted IP address (e.g., an IP address associated with previous successful login attempts or an IP address that is otherwise trusted by the identity management system) may be an example of a low risk attribute, while an untrusted (e.g., an IP address associated with a malicious user or an IP address unassociated with the use account) may be an example of a high risk attribute. The identity management system 120 may respond to the one or more requests according to a risk score (e.g., low or high) determined by the risk assessment model. For example, the identity management system 120 may configure a threshold risk score associated with the high risk class. In some examples, the identity management system 120 may leverage the MFA service 160 to prompt the user 185 to provide authentication factors. For example, the identity management system 120 may trigger the MFA service 160 to authenticate the user 185 based on the risk score. The identity management system 120 may continuously monitor the risk score based on receiving requests (e.g., in-session requests) to mitigate in-session threats to security of the user account.

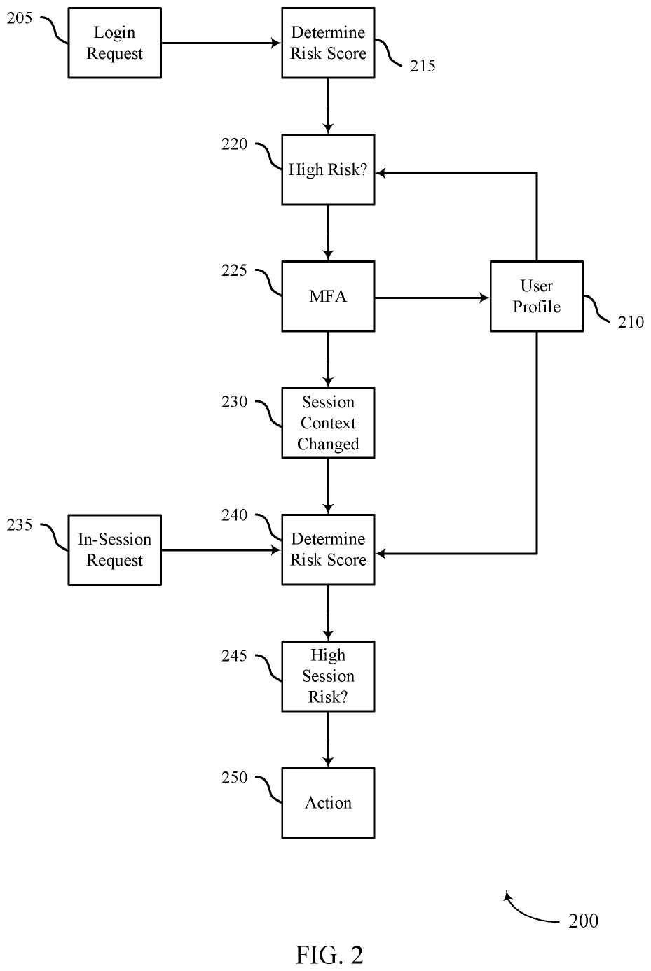

FIG. 2 shows an example of a flowchart 200 that supports risk score assessment by a machine learning model in accordance with aspects of the present disclosure. In some examples, the flowchart 200 may implement or be implemented by aspects of the system 100. For example, the flowchart 200 may be implemented at one or more devices (e.g., servers) of the identity management system 120 as illustrated by and described with reference to FIG. 1.

An identity management system may determine a risk score via a risk assessment model based on receiving one or more requests to access a user account. The identity management system may respond to the one or more requests based on the risk score. For example, the identity management system may grant one or more tokens, refrain from granting one or more tokens, or both based on the risk score.

The identity management system may train the risk assessment model via positive and negative sampling. In some examples, to train the risk assessment model (e.g., offline), the identity management system may input successful MFA results to the risk assessment model. For example, the identity management system may leverage successful MFA results as a negative class for the risk assessment model. The identity management system may input sets of attributes associated with successful MFA results for a user account to the risk assessment model.

The identity management system may refrain from leveraging unsuccessful MFA results as a positive class for training the risk assessment model. For example, unsuccessful MFA results may be associated with user error (e.g., rather than malicious activity). The identity management system may leverage MFA results for different user accounts as a positive class for training the risk assessment model. For example, the identity management system may input, as the positive class for training the risk assessment model, sets of attributes associated with MFA results (e.g., successful, unsuccessful, or both) from one or more user accounts different than the user account (e.g., the user account associated with the request). In some examples, the risk assessment model may randomly select a user from a database of users (e.g., via random sampling) to compare against the attributes of the user profile 210.

At 205, the identity management system may receive an authorization request (e.g., a login or sign on request) via an APIs. For example, the identity management system may receive a request to access (e.g., sign on to) a user account associated with the identity management system. The authorization request may be associated with one or more attributes. For example, the authorization request may be associated with an IP address, a type of device, a browser, an operating system of a device, a geographic location, an identifier, a managed state, or any combination thereof.

The identity management system may obtain the one or more attributes via one or more types of data signals. For example, the identity management system may obtain the one or more attributes based on data signals obtained via an API call (e.g., via a user calling an application API for application login), or via one or more data signals obtained via an authenticator application of the identity management system (e.g., operating on a device of the user), or both. For example, the one or more attributes may correspond to information transmitted via or otherwise associated with the API call, such as a token used to authenticate the API call, an IP address from which the API call originated, or an HTTP header, among other examples of information that may be obtained via an API call. Additionally, or alternatively, the authenticator application of the identity management system may access (or otherwise obtain) the one or more attributes (e.g., directly). For example, the authenticator application may be running on the device of the user and, as such may directly obtain information associated with the device, as well as other information that may be obtained via interactions between the user and the authenticator application. It is to be understood that the types of data signals and attributes described herein are examples and other types of data signals and attributes obtainable via an identity management system are not precluded. The examples described herein should not be considered limiting to the scope covered by the claims or the disclosure.

In some examples, the identity management system may filter login requests. For example, the identity management system may filter incoming requests according to a policy associated with a user account (e.g., an organization policy, where the user account is associated with an organization). The policy may include one or more restrictions, such as restricting access from unmanaged devices. The identity management system may filter these requests after receipt and, in some examples, may refrain from inputting filtered requests to the risk assessment model. For example, the risk assessment model may determine risk scores for requests meeting the policy associated with the user account.

At 215, the risk assessment model associated with the identity management system may determine a risk score. For example, the identity management system may input the one or more attributes associated with the login request received at 205 to the risk assessment model.

At 220, the risk assessment model may determine a classification for the risk score. For example, the risk assessment model, which may be a GBM algorithm, may determine positive (e.g., high risk) and negative (e.g., low risk) classes based on data sets input (e.g., data associated with IP addresses, geographic locations) to the risk assessment model by the identity management system (e.g., during offline training).

The risk assessment model may compare the attributes associated with the login request received at 205 against the associated user profile 210. For example, a user profile 210 may include a set of stored attributes, such as the attributes associated with successful MFA results. The risk assessment model may compare the set of stored attributes associated with the user profile 210 to the attributes associated with the login request. (e.g., using the trained risk assessment model).

The risk assessment model may be a binary classifier. For example, the risk assessment model may classify the one or more attributes associated with the login request at 205 as high risk or low risk. The identity management system may configure a threshold between high risk and low risk. For example, the identity management system may configure the risk assessment model to identify attributes associated with requests having a threshold deviation from the set of user attributes associated with the user profile 210 as high risk. That is, the identity management system may establish a low risk range based on collecting the user attributes associated with successful MFA results, and configure requests outside of the low risk range as high risk.

At 225, the identity management system may transmit an MFA request for the user account. For example, the identity management system may trigger the MFA request based on classifying the risk score as high risk at 220. In some examples, the result of the MFA request may be used to update a pattern associated with the user profile 210. That is, a successful MFA result at 430 may be used to update the set of user attributes associated with the user profile 210.

At 230, a session context may change. For example, the session context may change from pre-session to in-session based on a success of the MFA request at 225. That is, the identity management system may establish a session with the user account.

At 235, the identity management system may receive an in-session request. For example, the identity management system may receive a request to access the user account associated with the identity management system during the session established at 230. The in-session request may be associated with one or more second attributes. For example, the in-session request may be associated with an IP address, a type of device, a browser, an operating system of a device, a geographic location, an identifier, a managed state, or any combination thereof.

In some examples, the identity management system may obtain the one or more second attributes via an API call, via one or more signals associated with an authenticator application of the identity management system, or both. For example, the identity management system may identify the one or more attributes based on a data signal used to transmit the API call. Or the authenticator application associated with the identity management system may access the one or more second attributes (e.g., directly) based on receiving a request via a device having the authenticator application.

At 240, the identity management system may determine a risk score. For example, the identity management system may input the one or more second attributes associated with the in-session request received at 235 to the risk assessment model.

At 245, the risk assessment model may determine a classification for the risk score. For example, the risk assessment model may determine positive (e.g., high risk) and negative (e.g., low risk) classes via data sets input to the risk assessment model by the identity management system, as well as the additional updates to the set of attributes associated with the user profile 210 based on the result of the MFA request at 225.

At 250, the identity management system may perform an action based on classifying the session risk at 245. For example, the identity management system may issue one or more tokens based on identifying a low risk score associated with the in-session request. Or the identity management system may refrain from issuing one or more tokens based on identifying a high risk score associated with the in-session request. For example, the identity management system may restrict access to the user account during an established session by continuously monitoring the risk score based on received in-session requests. Additionally, or alternatively, the identity management system may issue one or more (e.g., additional) MFA requests. The identity management system may perform the action to reduce a risk of session hijacking. For example, the identity management system may restrict access to a user account during a session based on continuously monitored risk.

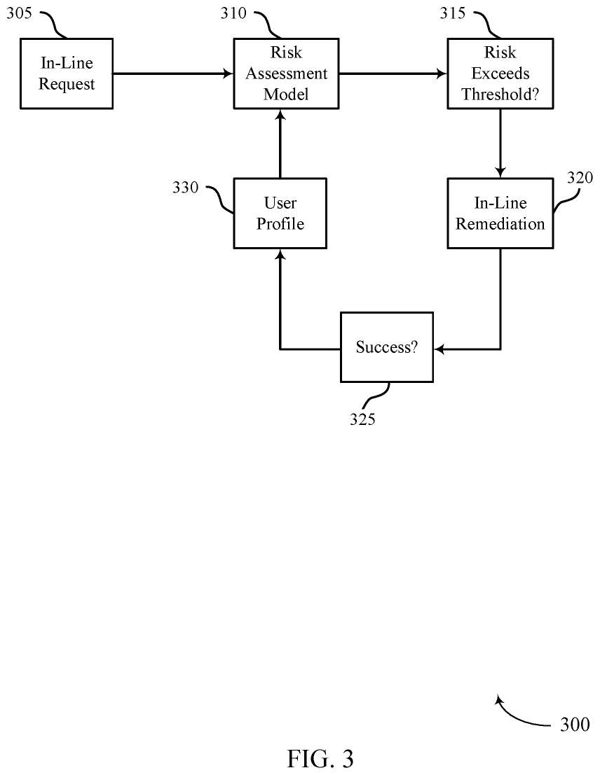

FIG. 3 shows an example of a flowchart 300 that supports risk score assessment by a machine learning model in accordance with aspects of the present disclosure. In some examples, the flowchart 200 may implement or be implemented by aspects of the system 100. For example, the flowchart 200 may be implemented at the identity management system 120 as illustrated by and described with reference to FIG. 1.

An identity management system may determine a risk score via a risk assessment model based on receiving one or more requests to access a user account. The identity management system may respond to the one or more requests based on the risk score. For example, the identity management system may grant one or more tokens, refrain from granting one or more tokens, or both based on the risk score.

At 305, the identity management system may receive an in-line request. For example, the identity management system may receive one or more requests to access a user account during a session (e.g., an established session). The identity management system may receive an authorization request (e.g., a log in or sign on request) prior to receiving the in-line request, and, in some examples, the identity management system may perform an MFA request based on receiving the login request (e.g., at 225 in the example of FIG. 2).

The in-line request may be associated with one or more attributes. For example, the identity management system may identify the one or more attributes associated with the in-line request via a system log, based on a signal associated with the in-line request, or both. The one or more attributes may include an IP address associated with a source of the in-line request, a type of device associated with the source of the in-line request, a token (e.g., a device token) used for the request, an autonomous system number (ASN) of a network associated with the request, an HTTP header included in the request, a browser associated with the source of the in-line request, an operating system of a device associated with the source of the in-line request, a geographic location associated with the in-line of the first request, an identifier of the device associated with the source of the in-line request, or a managed state of the device associated with the source of the in-line request, or any combination thereof.

At 310, the identity management system may input the one or more attributes associated with the in-line request to the risk assessment model. The risk assessment model may compare the one or more attributes to a pattern associated with the user profile. In some examples, the risk assessment model may be associated with one or more supervised machine learning algorithms (e.g., GBM, neural network, linear regression, logistical regression, decision tree, random forests, support vector machine, K-nearest neighbors).

In some examples, the risk assessment model may compare the one or more attributes to the pattern via a GBM algorithm. For example, the risk assessment model may determine a classification (e.g., a binary classification) for the in-line request according to the risk assessment model, where the risk assessment model is trained via respective sets of positive and negative samples. The classification of requests received by the identity management system is described further with reference to steps 220 and 245 of the flowchart 200.

Additionally, or alternatively, the risk assessment model may compare the one or more attributes to the pattern via a neural network, such as a Siamese neural network (SNN) model. The SNN model may include a pseudo-image generator, an SNN, and a continuous identity verification engine.

The identity management system may develop the SNN based on pseudo-image embeddings for continuous authentication using information available in a system log of the SNN. For example, the pseudo-image generator may generate pseudo-images based on system log information. The system log information may include a set of patterns associated with the user profile, the one or more attributes associated with the in-line request, or both. For example, the system log information may include, for respective requests, a geographic location associated with a source of the in-line request, an IP address associated with the source of the in-line request, a device associated with the source of the in-line request, an operating system associated with the source of the in-line request, a browser associated with the source of the in-line request, a time that the in-line request is transmitted and/or received, keystroke dynamics, mouse tracking patterns, applications associated with the in-line request, or one or more additional signals (e.g., device biometrics).

The pseudo-image generator may encode system log information for an attribute of the one or more attributes to a pseudo-image grid. The grid may be elastic, and the SNN may modify or expand the grid as additional signals are collected by the identity management system. The grid may be initialized as “zeros” (e.g., padded). The SNN may apply a transformation to encode one or more signals (e.g., of the system log) to the pseudo-image grid. The SNN may associate the encoded one or more signals with a feature label and encode the signals to corresponding locations on the pseudo-image grid. The SNN may normalize the encoded values on the pseudo-image grid.

The identity management system may train the SNN via a set of pseudo-images collected over a duration. For example, the identity management system may generate the set of pseudo-images based on successful MFA results for the user profile (e.g., positive samples). The identity management system may generate negative samples based on random selection of a set of pseudo-images unaffiliated with the user profile (e.g., from other user profiles).

The identity management system may develop the SNN via the generated positive and negative samples. The SNN may compare image embeddings associated with pseudo-images from the positive samples and the negative sets via a contrastive loss function.

The continuous identity verification engine may evaluate risk according to the SNN pseudo-image embeddings (e.g., embedding vectors). The continuous identity verification engine may compare a determined similarity score to a threshold similarity score to classify the in-line request as high risk or low risk.

At 315, the identity management system may determine whether the risk score exceeds a threshold. For example, the identity management system may determine whether a risk score produced by the GBM algorithm, the SNN, or both exceeds a threshold risk score.

At 320, the identity management system may perform in-line remediation. For example, the identity management system may trigger an MFA based on determining that the risk score exceeds the threshold. The identity management system may refrain from granting access to the user account based on the MFA result. For example, the identity management system may refrain from granting access to the user account until the MFA is complete.

At 325, the identity management system may evaluate a result of the in-line remediation. For example, the identity management system may refrain from granting access to the user account based on an unsuccessful MFA result. Or the identity management system may grant access to the user account based on a successful MFA result.

At 330, the identity management system may update the user profile based on the result of the in-line remediation. For example, the identity management system may input one or more attributes associated with requests resulting in a successful MFA to the user profile. The risk assessment model may use the updated user profile to evaluate attributes associated with subsequent requests.

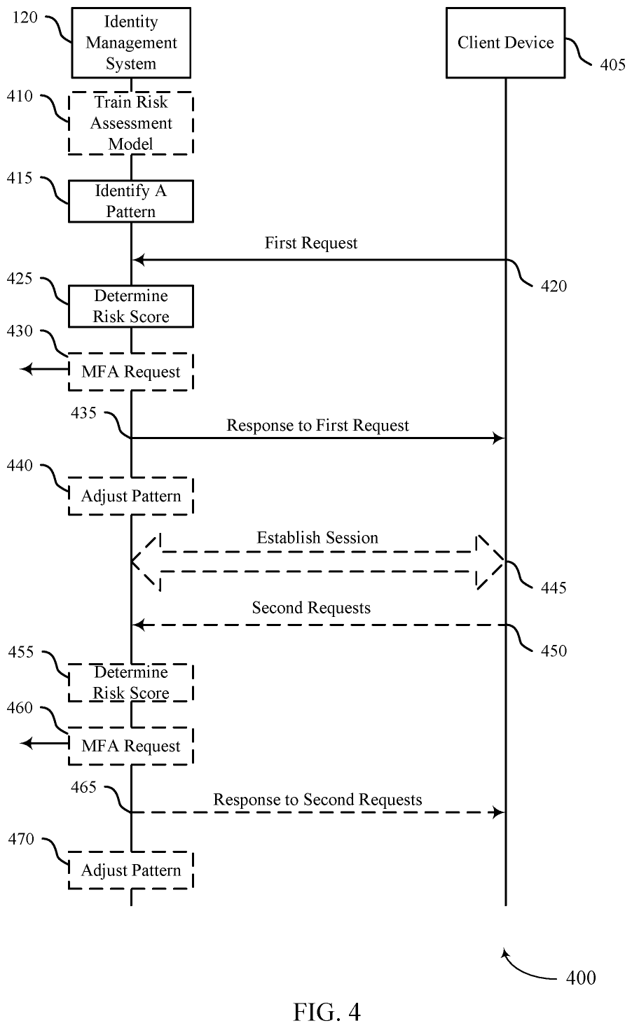

FIG. 4 shows an example of a process flow 400 that supports risk score assessment by a machine learning model in accordance with aspects of the present disclosure. In some examples, the process flow 400 may implement aspects of the system 100 and the flowcharts 200 and 300. For example, the process flow 400 may illustrate operations at an identity management system 120, which may each be an example of the identity management system 120 illustrated by and described with reference to FIG. 1. The process flow 400 may also include client device 405, which may be an example of a computing device 105 illustrated by and described with reference to FIG. 1.

In the following description of the process flow 400, the operations performed at the identity management system 120 and the client device 405 may be performed in different orders or at different times than shown. Additionally, or alternatively, some operations may be omitted from the process flow 400 and other operations may be added to the process flow 400.

The identity management system 120 may receive one or more requests to access a user account. For example, the identity management system 120 may receive login requests, in-session requests, or both. The identity management system 120 may respond to the one or more requests based on determining, via a risk assessment model, a risk score associated with each respective request. For example, the risk assessment model may determine the risk score based on comparing attributes associated with respective requests to a pattern of the user account.

At 410, the identity management system 120 may train the risk assessment model. For example, the identity management system 120 may train the risk assessment model to categorize requests into a first class associated with a first type of attribute (e.g., high risk) or a second class associated with a second type of attribute (e.g., low risk), the second type of attribute being associated with lower risk than the first type of attribute.

To train the risk assessment model, the identity management system may input a first set of attributes, the first set of attributes being associated with the first class, and input a second set of attributes, the second set of attributes being associated with the second class. The risk assessment model may determine the risk score based on one or more differences between the first set of attributes and the second set of attributes. In some examples, the first set of attributes, the second set of attributes, or both may be of a set of attributes associated with the user account.

The first set of attributes and the second set of attributes may represent positive samples and negative samples, respectively, used by the risk assessment model to determine categories for requests received by the identity management system 120. For example, the risk assessment model may be an example of a GBM algorithm.

At 415, the identity management system 120 may identify a pattern at a first device of the identity management system 120. For example, the identity management system 120 may identify the pattern associated with the user account. The risk assessment model associated with the identity management system 120 may identify the pattern based on the set of attributes associated with the user account. For example, the identity management system 120 may obtain the set of attributes over a duration.

The identity management system 120 may obtain at least one attribute of the set of attributes based on a data signal associated with one or more interactions between the user account and one or more applications associated with the identity management system 120. For example, the identity management system 120 may obtain the attributes based on interactions between the user account and applications accessed (e.g., or attempted to be accessed) by a user via the identity management system 120 (e.g., via calls to or from the API during a session).

Additionally, or alternatively, the identity management system 120 may obtain at least one attribute of the set of attributes based on a data signal from an authenticator application of a device associated with the user account, wherein the authenticator application is associated with the identity management system 120. For example, the identity management system 120 may obtain the attributes based on activity on the authenticator application (e.g., via calls to or from an API of the authenticator application).

At 420, the identity management system 120 may receive a first request from a second device via an API. For example, the identity management system 120 may receive the first request from the client device 405. The first request may be associated with one or more attributes. For example, the one or more attributes may include an IP address associated with a source of the first request, a type of device associated with the source of the first request, a browser associated with the source of the first request, an operating system of a device associated with the source of the first request, a geographic location associated with the source of the first request, an identifier of the device associated with the source of the first request, or a managed state of the device associated with the source of the first request, or any combination thereof. The one or more attributes may also include attributes not listed here. In some examples, the first request may be an authentication request for access to the user account. For example, the first request may be a sign-in attempt.

At 425, the identity management system 120 may determine a risk score. For example, the identity management system 120 may determine the risk score based on receiving the first request at 420, which may be an authentication request. The identity management system 120 may determine the risk score using the risk assessment model. For example, the risk assessment model may determine the risk score based on a difference between the one or more attributes of the request and the pattern associated with the user account. The risk assessment model may determine the risk score by identifying whether or not deviation exists between the one or more attributes and the pattern. For example, the risk assessment model (e.g., a gradient boosting mechanism) may identify that the one or more attributes deviate from a range (e.g., a classification) established during the training of the risk assessment model at 410.

In some examples, the identity management system 120 may classify the risk score (e.g., into high risk or low risk) based on a risk threshold (e.g., a preconfigured threshold). For example, the identity management system 120 may use the risk threshold to classify the risk score and respond to one or more requests. The risk threshold may be preconfigured by a tenant (e.g., associated with the user account) based on a risk or friction tolerance of the tenant.

At 430, the identity management system 120 may trigger an MFA request. For example, the identity management system 120 may trigger the MFA request for the user account based on the risk score satisfying the risk threshold, where the response to the first request is based on whether the MFA request is successful, and where the first request is a login request.

At 435, the identity management system 120 may respond to the first request. For example, the identity management system 120 may respond to the first request based on whether the risk score satisfies the risk threshold. In some examples, the identity management system 120 may refrain from granting access to the user account (e.g., refrain from issuing a token) based on identifying a high risk score (e.g., a risk score above the risk threshold). Or the identity management system 120 may grant access to the user account (e.g., issue a token) based on identifying a low risk score (e.g., a risk score below the risk threshold).

At 440, the identity management system 120 may adjust the pattern. For example, the identity management system 120 may perform an adjustment to the pattern based on whether the MFA request at 430 is successful. The identity management system may collect one or more attributes of the client device 405 associated with a successful MFA result for the pattern. For example, the pattern may be associated with attributes of a quantity of most recent successful MFA results.

In some examples, the identity management system 120 may input a successful MFA request result to the risk assessment model as a negative class. That is, the successful MFA result may be used to train the risk assessment model to identify low risk.

At 445, the identity management system 120 may establish a session with the client device 405. For example, the identity management system 120 may establish the session with the user account (e.g., accessed via the client device 405) based on a successful MFA result at 430. The establishment of the session may be in accordance with the response to the first request at 435. For example, the identity management system may issue a token establishing the session at 445.

At 450, the identity management system 120 may receive one or more second requests. For example, the identity management system 120 may receive one or more in-session requests for the user account, where the one or more in-session requests are associated with one or more second attributes. The one or more second attributes may include an IP address associated with a source of the one or more second requests, a type of device associated with the source of the one or more second requests, a browser associated with the source of the one or more second requests, an operating system of a device associated with the source of the one or more second requests, a geographic location associated with the source of the one or more second requests, an identifier of the device associated with the source of the one or more second requests, or a managed state of the device associated with the source of the one or more second requests, or any combination thereof. The one or more second attributes may also include attributes not listed here.

At 455, the identity management system 120 may determine a second risk score. For example, the identity management system 120 may determine the second risk score based on receiving the first request at 450, which may be an in-session request. The identity management system 120 may determine the second risk score via the risk assessment model. For example, the risk assessment model may determine the second risk score based on a difference between the one or more second attributes of the one or more second requests and the pattern associated with the user account. For example, the pattern may be the adjusted pattern determined at 440. That is, the identity management system 120 may continuously update the pattern and use the updated pattern to determine subsequent risk scores.

In some examples, the identity management system 120 may classify the risk score (e.g., into high risk or low risk) based on a risk threshold (e.g., a preconfigured threshold). The risk threshold may be the same or different than the risk threshold used to classify the risk score associated with the first request.

At 460, the identity management system 120 may trigger an MFA request. For example, the identity management system 120 may trigger the MFA request for the user account based on the second risk score satisfying the risk threshold, where the response to the one or more second requests is based on whether the MFA request is successful, and where the one or more second requests are in-session requests.

At 465, the identity management system 120 may respond to the one or more second requests. For example, the identity management system 120 may respond to the one or more second requests based on whether the MFA request is successful at 460. based on whether the risk score satisfies the risk threshold. In some examples, the identity management system 120 may refrain from granting access to the user account (e.g., refrain from issuing one or more tokens) based on identifying a high risk score (e.g., a risk score above the risk threshold). Or the identity management system 120 may grant access to the user account (e.g., issue one or more tokens) based on identifying a low risk score (e.g., a risk score below the risk threshold).

At 470, the identity management system 120 may adjust the pattern. For example, the identity management system 120 may perform an adjustment to the pattern based on whether the MFA request at 460 is successful. The identity management system may collect one or more attributes of the client device 405 associated with a successful MFA result for the pattern. For example, the pattern may be associated with attributes of a quantity of most recent successful MFA results.

In some examples, the identity management system 120 may input a successful MFA request result to the risk assessment model as a negative class. That is, the successful MFA result may be used to train the risk assessment model to identify low risk.

The identity management system 120 may continuously evaluate risk based on receiving subsequent requests. For example, the identity management system 120 may perform steps 420 through 440 based on receiving subsequent authorization requests and steps 450 through 470 based on receiving subsequent in-session requests. The identity management system 120 may continuously update the pattern based on determining risk scores, based on a success of an MFA request, or both. In some examples, the identity management system 120 may provide one or more additional inputs to the risk assessment model to retrain or calibrate the risk assessment model. For example, the identity management system 120 may perform step 410 throughout the process flow 400.

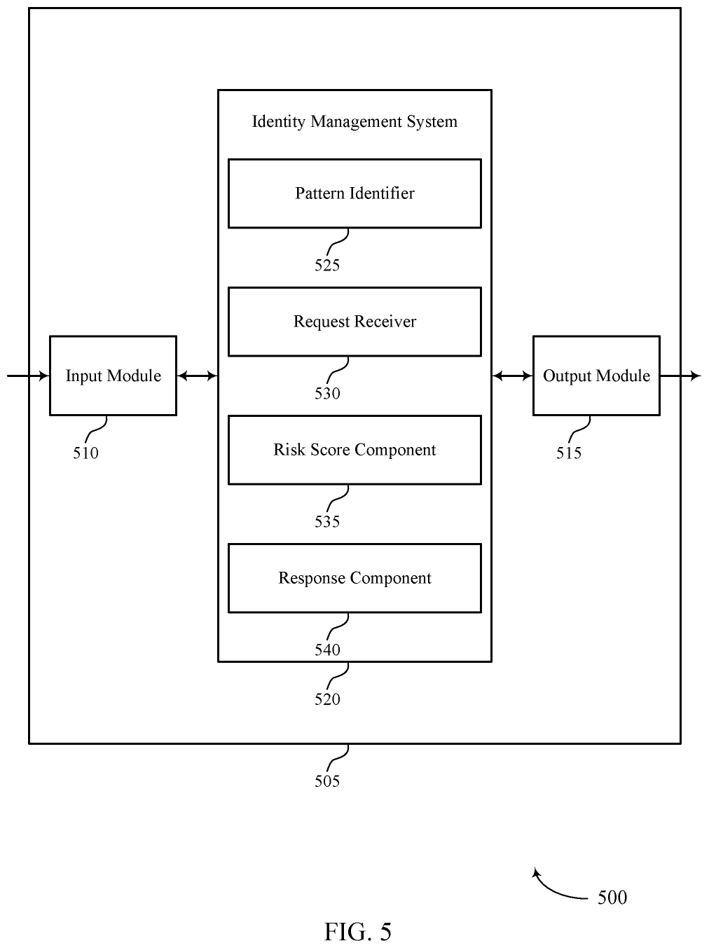

FIG. 5 shows a block diagram 500 of a device 505 that supports risk score assessment by a machine learning model in accordance with aspects of the present disclosure. The device 505 may include an input module 510, an output module 515, and an identity management system 520. The device 505, or one or more components of the device 505 (e.g., the input module 510, the output module 515, and the identity management system 520), may include at least one processor, which may be coupled with at least one memory, to support the described techniques. Each of these components may be in communication with one another (e.g., via one or more buses).

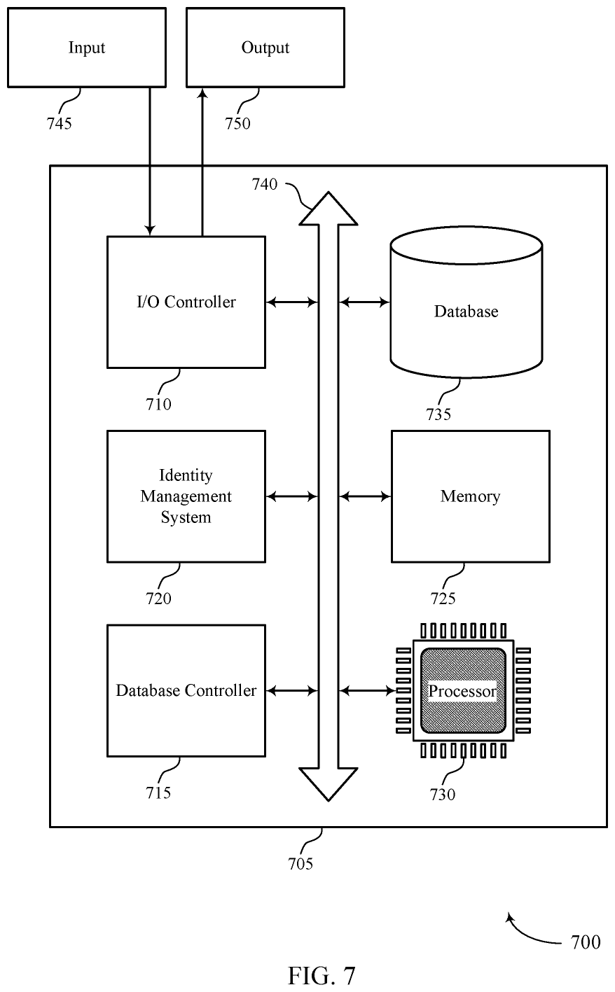

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the identity management system 520 to support risk score assessment by a machine learning model. In some cases, the input module 510 may be a component of an input/output (I/O) controller 710 as described with reference to FIG. 7.

The output module 515 may manage output signals for the device 505. For example, the output module 515 may receive signals from other components of the device 505, such as the identity management system 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the identity management system 520 may include a pattern identifier 525, a request receiver 530, a risk score component 535, a response component 540, or any combination thereof. In some examples, the identity management system 520, or various components thereof, may be configured to perform various operations (e.g., receiving, monitoring, transmitting) using or otherwise in cooperation with the input module 510, the output module 515, or both. For example, the identity management system 520 may receive information from the input module 510, send information to the output module 515, or be integrated in combination with the input module 510, the output module 515, or both to receive information, transmit information, or perform various other operations as described herein.

The pattern identifier 525 may be configured to support identifying, at a first device of an identity management system, a pattern associated with a user account of the identity management system, where the pattern is identified using at least a risk assessment model, and where the pattern is based on a set of multiple attributes of the user account obtained at the identity management system over a duration. The request receiver 530 may be configured to support receiving, from a second device via an API, a first request for the user account, the first request being associated with one or more first attributes. The risk score component 535 may be configured to support determining, at the first device using the risk assessment model, a risk score based on a first difference between the one or more first attributes and the pattern. The response component 540 may be configured to support responding to the first request based on whether the risk score satisfies a threshold.

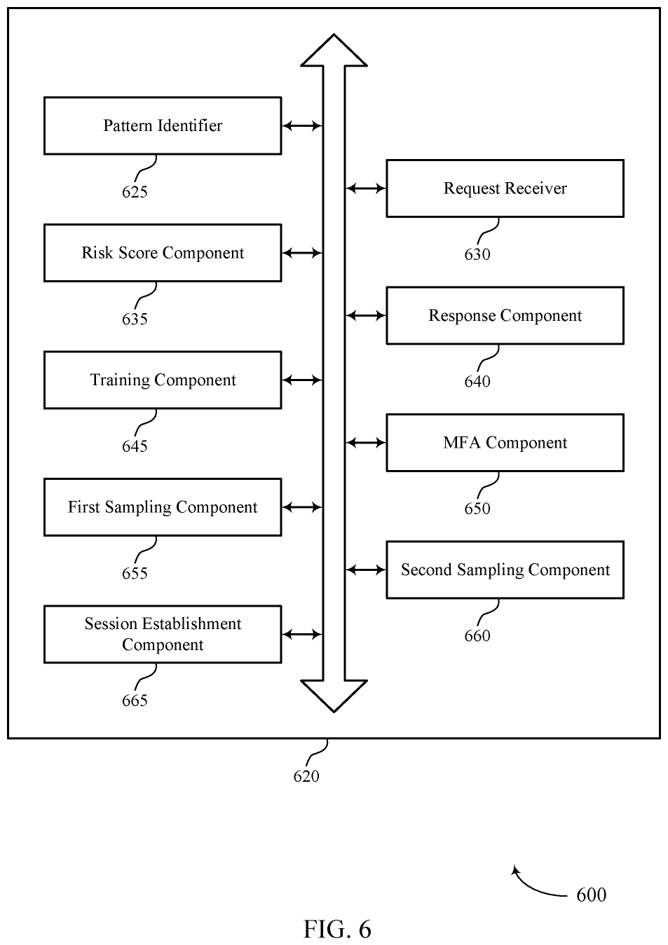

FIG. 6 shows a block diagram 600 of an identity management system 620 that supports risk score assessment by a machine learning model in accordance with aspects of the present disclosure. The identity management system 620 may be an example of aspects of an identity management system or an identity management system 520, or both, as described herein. The identity management system 620, or various components thereof, may be an example of means for performing various aspects of risk score assessment by a risk assessment model as described herein. For example, the identity management system 620 may include a pattern identifier 625, a request receiver 630, a risk score component 635, a response component 640, a training component 645, an MFA component 650, a first sampling component 655, a second sampling component 660, a session establishment component 665, or any combination thereof. Each of these components, or components of subcomponents thereof (e.g., one or more processors, one or more memories), may communicate, directly or indirectly, with one another (e.g., via one or more buses).

The pattern identifier 625 may be configured to support identifying, at a first device of an identity management system, a pattern associated with a user account of the identity management system, where the pattern is identified using at least a risk assessment model, and where the pattern is based on a set of multiple attributes of the user account obtained at the identity management system over a duration. The request receiver 630 may be configured to support receiving, from a second device via an API, a first request for the user account, the first request being associated with one or more first attributes. The risk score component 635 may be configured to support determining, at the first device using the risk assessment model, a risk score based on a first difference between the one or more first attributes and the pattern. The response component 640 may be configured to support responding to the first request based on whether the risk score satisfies a threshold.

In some examples, the training component 645 may be configured to support training the risk assessment model to categorize requests into a first class associated with a first type of attribute or a second class associated with a second type of attribute, the second type of attribute being associated with lower risk than the first type of attribute.

In some examples, to support training the risk assessment model, the first sampling component 655 may be configured to support inputting, to the risk assessment model, a first set of attributes of the set of multiple attributes, the first set of attributes being associated with the first class. In some examples, to support training the risk assessment model, the second sampling component 660 may be configured to support inputting, to the risk assessment model, a second set of attributes of the set of multiple attributes, the second set of attributes being associated with the second class, where determining the risk score is based on one or more differences between the first set of attributes and the second set of attributes. In some examples, the risk assessment model includes a GBM algorithm.

In some examples, to support receiving the first request, the request receiver 630 may be configured to support receiving an authentication request for access to the user account. In some examples, to support receiving the first request, the risk score component 635 may be configured to support determining the risk score in response to receiving the authentication request.

In some examples, the session establishment component 665 may be configured to support establishing a session for the user account with the identity management system in accordance with the response to the first request. In some examples, the request receiver 630 may be configured to support receiving, during the session, one or more second requests for the user account, the one or more second requests being associated with one or more second attributes. In some examples, the risk score component 635 may be configured to support determining, via the risk assessment model in response to the one or more second requests, a second risk score based on a second difference between the one or more second attributes and the pattern. In some examples, the response component 640 may be configured to support responding to the one or more second requests based on whether the second risk score satisfies the threshold.

In some examples, the MFA component 650 may be configured to support triggering an MFA request for the user account based on the second risk score satisfying the threshold, where the response to the one or more second requests are based on whether the MFA request is successful, where second request is an in-session request.

In some examples, the pattern identifier 625 may be configured to support performing an adjustment to the pattern, where the adjustment is based on whether the MFA request is successful.

In some examples, the MFA component 650 may be configured to support triggering an MFA request for the user account based on the first risk score satisfying the threshold, where the response to the first request is based on whether the MFA request is successful, where the first request is a login request.

In some examples, the pattern identifier 625 may be configured to support performing an adjustment to the pattern, where the adjustment is based on whether the MFA request is successful. In some examples, risk scores associated with subsequent requests are based on the adjusted pattern.

In some examples, the one or more first attributes include an IP address associated with a source of the first request, a type of device associated with the source of the first request, a browser associated with the source of the first request, an operating system of a device associated with the source of the first request, a geographic location associated with the source of the first request, an identifier of the device associated with the source of the first request, or a managed state of the device associated with the source of the first request, or any combination thereof.

In some examples, the request receiver 630 may be configured to support obtaining at least one attribute of the set of multiple attributes based on a data signal associated with one or more interactions between the user account and one or more applications associated with the identity management system.

In some examples, the request receiver 630 may be configured to support obtaining at least one attribute of the set of multiple attributes based on a data signal from an authenticator application of a device associated with the user account, where the authenticator application is associated with the identity management system.

FIG. 7 shows a diagram of a system 700 including a device 705 that supports risk score assessment by a machine learning model in accordance with aspects of the present disclosure. The device 705 may be an example of or include the components of a device 505 as described herein. The device 705 may include components for bi-directional voice and data communications including components for transmitting and receiving communications, such as an identity management system 720, an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting risk score assessment by a machine learning model). The processor 730 may be an example of a single processor or multiple processors. For example, the device 705 may include one or more processors 730.

For example, the identity management system 720 may be configured to support identifying, at a first device of an identity management system, a pattern associated with a user account of the identity management system, where the pattern is identified using at least a risk assessment model, and where the pattern is based on a set of multiple attributes of the user account obtained at the identity management system over a duration. The identity management system 720 may be configured to support receiving, from a second device via an API, a first request for the user account, the first request being associated with one or more first attributes. The identity management system 720 may be configured to support determining, at the first device using the risk assessment model, a risk score based on a first difference between the one or more first attributes and the pattern. The identity management system 720 may be configured to support responding to the first request based on whether the risk score satisfies a threshold.

By including or configuring the identity management system 720 in accordance with examples as described herein, the device 705 may support techniques for improved security and reduced latency.

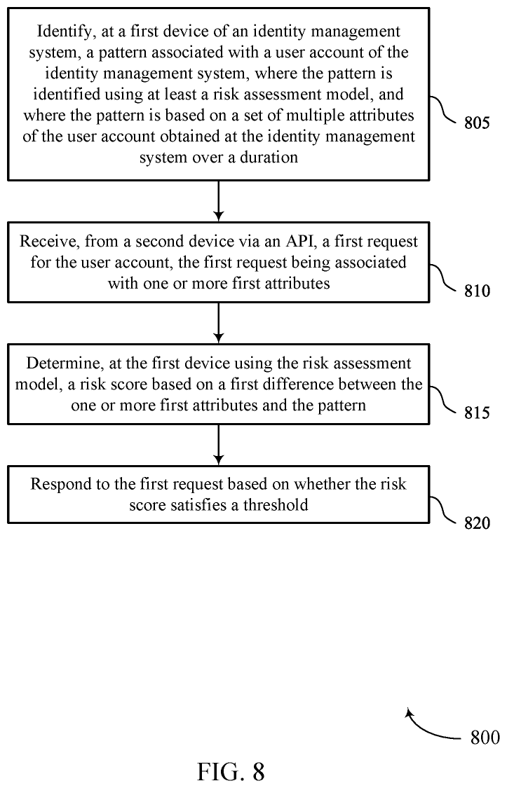

FIG. 8 shows a flowchart illustrating a method 800 that supports risk score assessment by a machine learning model in accordance with aspects of the present disclosure. The operations of the method 800 may be implemented by an identity management system or its components as described herein. For example, the operations of the method 800 may be performed by an identity management system as described with reference to FIGS. 1 through 7. In some examples, an identity management system may execute a set of instructions to control the functional elements of the identity management system to perform the described functions. Additionally, or alternatively, the identity management system may perform aspects of the described functions using special-purpose hardware.

At 805, the method may include identifying, at a first device of an identity management system, a pattern associated with a user account of the identity management system, where the pattern is identified using at least a risk assessment model, and where the pattern is based on a set of multiple attributes of the user account obtained at the identity management system over a duration. The operations of block 805 may be performed in accordance with examples as disclosed herein. In some examples, aspects of the operations of 805 may be performed by a pattern identifier 625 as described with reference to FIG. 6.

At 810, the method may include receiving, from a second device via an API, a first request for the user account, the first request being associated with one or more first attributes. The operations of block 810 may be performed in accordance with examples as disclosed herein. In some examples, aspects of the operations of 810 may be performed by a request receiver 630 as described with reference to FIG. 6.

At 815, the method may include determining, at the first device using the risk assessment model, a risk score based on a first difference between the one or more first attributes and the pattern. The operations of block 815 may be performed in accordance with examples as disclosed herein. In some examples, aspects of the operations of 815 may be performed by a risk score component 635 as described with reference to FIG. 6.

At 820, the method may include responding to the first request based on whether the risk score satisfies a threshold. The operations of block 820 may be performed in accordance with examples as disclosed herein. In some examples, aspects of the operations of 820 may be performed by a response component 640 as described with reference to FIG. 6.

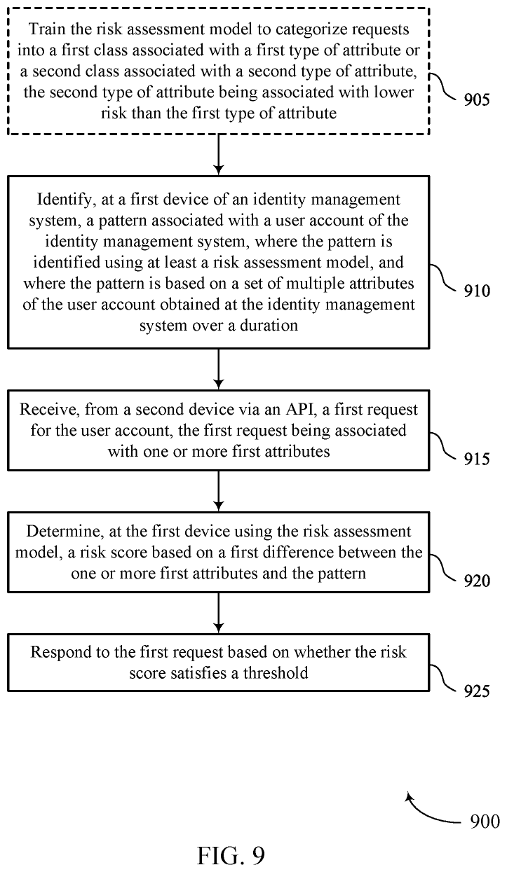

FIG. 9 shows a flowchart illustrating a method 900 that supports risk score assessment by a machine learning model in accordance with aspects of the present disclosure. The operations of the method 900 may be implemented by an identity management system or its components as described herein. For example, the operations of the method 900 may be performed by an identity management system as described with reference to FIGS. 1 through 7. In some examples, an identity management system may execute a set of instructions to control the functional elements of the identity management system to perform the described functions. Additionally, or alternatively, the identity management system may perform aspects of the described functions using special-purpose hardware.

At 905, the method may include training the risk assessment model to categorize requests into a first class associated with a first type of attribute or a second class associated with a second type of attribute, the second type of attribute being associated with lower risk than the first type of attribute. The operations of block 905 may be performed in accordance with examples as disclosed herein. In some examples, aspects of the operations of 905 may be performed by a training component 645 as described with reference to FIG. 6.

At 910, the method may include identifying, at a first device of an identity management system, a pattern associated with a user account of the identity management system, where the pattern is identified using at least a risk assessment model, and where the pattern is based on a set of multiple attributes of the user account obtained at the identity management system over a duration. The operations of block 910 may be performed in accordance with examples as disclosed herein. In some examples, aspects of the operations of 910 may be performed by a pattern identifier 625 as described with reference to FIG. 6.

At 915, the method may include receiving, from a second device via an API, a first request for the user account, the first request being associated with one or more first attributes. The operations of block 915 may be performed in accordance with examples as disclosed herein. In some examples, aspects of the operations of 915 may be performed by a request receiver 630 as described with reference to FIG. 6.

At 920, the method may include determining, at the first device using the risk assessment model, a risk score based on a first difference between the one or more first attributes and the pattern. The operations of block 920 may be performed in accordance with examples as disclosed herein. In some examples, aspects of the operations of 920 may be performed by a risk score component 635 as described with reference to FIG. 6.

At 925, the method may include responding to the first request based on whether the risk score satisfies a threshold. The operations of block 925 may be performed in accordance with examples as disclosed herein. In some examples, aspects of the operations of 925 may be performed by a response component 640 as described with reference to FIG. 6.

The following provides an overview of aspects of the present disclosure:

Aspect 1: A method for assessing risk associated with users of an identity management system, comprising: identifying, at a first device of the identity management system, a pattern associated with a user account of the identity management system, wherein the pattern is identified using at least a risk assessment model, and wherein the pattern is based at least in part on a plurality of attributes of the user account obtained at the identity management system over a duration; receiving, from a second device via an API, a first request for the user account, the first request being associated with one or more first attributes; determining, at the first device using the risk assessment model, a risk score based at least in part on a first difference between the one or more first attributes and the pattern; and responding to the first request based at least in part on whether the risk score satisfies a threshold.

Aspect 2: The method of aspect 1, further comprising: training the risk assessment model to categorize requests into a first class associated with a first type of attribute or a second class associated with a second type of attribute, the second type of attribute being associated with lower risk than the first type of attribute.

Aspect 3: The method of aspect 2, wherein training the risk assessment model comprises: inputting, to the risk assessment model, a first set of attributes of the plurality of attributes, the first set of attributes being associated with the first class; and inputting, to the risk assessment model, a second set of attributes of the plurality of attributes, the second set of attributes being associated with the second class, wherein determining the risk score is based at least in part on one or more differences between the first set of attributes and the second set of attributes.

Aspect 4: The method of any of aspects 2 through 3, wherein the risk assessment model comprises a GBM algorithm.

Aspect 5: The method of any of aspects 1 through 4, wherein receiving the first request comprises: receiving an authentication request for access to the user account; and determining the risk score in response to receiving the authentication request.

Aspect 6: The method of aspect 5, further comprising: establishing a session for the user account with the identity management system in accordance with the response to the first request; receiving, during the session, one or more second requests for the user account, the one or more second requests being associated with one or more second attributes; determining, via the risk assessment model in response to the one or more second requests, a second risk score based at least in part on a second difference between the one or more second attributes and the pattern; and responding to the one or more second requests based at least in part on whether the second risk score satisfies the threshold.

Aspect 7: The method of aspect 6, further comprising: triggering a MFA request for the user account based at least in part on the second risk score satisfying the threshold, wherein the response to the one or more second requests are based at least in part on whether the MFA request is successful, wherein second request is an in-session request.

Aspect 8: The method of aspect 7, further comprising: performing an adjustment to the pattern, wherein the adjustment is based at least in part on whether the MFA request is successful.

Aspect 9: The method of any of aspects 1 through 8, further comprising: triggering a MFA request for the user account based at least in part on the first risk score satisfying the threshold, wherein the response to the first request is based at least in part on whether the MFA request is successful, wherein the first request is a login request.

Aspect 10: The method of aspect 9, further comprising: performing an adjustment to the pattern, wherein the adjustment is based at least in part on whether the MFA request is successful.

Aspect 11: The method of aspect 10, wherein risk scores associated with subsequent requests are based on the adjusted pattern.

Aspect 12: The method of any of aspects 1 through 11, wherein the one or more first attributes comprise an IP address associated with a source of the first request, a type of device associated with the source of the first request, a browser associated with the source of the first request, an operating system of a device associated with the source of the first request, a geographic location associated with the source of the first request, an identifier of the device associated with the source of the first request, or a managed state of the device associated with the source of the first request, or any combination thereof.

Aspect 13: The method of any of aspects 1 through 12, further comprising: obtaining at least one attribute of the plurality of attributes based at least in part on a data signal associated with one or more interactions between the user account and one or more applications associated with the identity management system.

Aspect 14: The method of any of aspects 1 through 13, further comprising: obtaining at least one attribute of the plurality of attributes based at least in part on a data signal from an authenticator application of a device associated with the user account, wherein the authenticator application is associated with the identity management system.

Aspect 15: An apparatus comprising one or more memories storing processor-executable code, and one or more processors coupled with the one or more memories and individually or collectively operable to execute the code to cause the apparatus to perform a method of any of aspects 1 through 14.

Aspect 16: An apparatus comprising at least one means for performing a method of any of aspects 1 through 14.

Aspect 17: A non-transitory computer-readable medium storing code the code comprising instructions executable by a processor to perform a method of any of aspects 1 through 14.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for assessing risk associated with users of an identity management system, comprising:
identifying, at a first device of the identity management system, a pattern associated with a user account of the identity management system, wherein the pattern is identified using at least a risk assessment model, and wherein the pattern is based at least in part on a plurality of attributes of the user account obtained at the identity management system over a duration;
receiving, from a second device via an application programming interface, a first request for the user account, the first request being associated with one or more first attributes;
determining, at the first device using the risk assessment model, a risk score based at least in part on a first difference between the one or more first attributes and the pattern; and
responding to the first request based at least in part on whether the risk score satisfies a threshold.

2. The method of claim 1, further comprising:
training the risk assessment model to categorize requests into a first class associated with a first type of attribute or a second class associated with a second type of attribute, the second type of attribute being associated with lower risk than the first type of attribute.

3. The method of claim 2, wherein training the risk assessment model comprises:
inputting, to the risk assessment model, a first set of attributes of the plurality of attributes, the first set of attributes being associated with the first class; and
inputting, to the risk assessment model, a second set of attributes of the plurality of attributes, the second set of attributes being associated with the second class, wherein determining the risk score is based at least in part on one or more differences between the first set of attributes and the second set of attributes.

4. The method of claim 2, wherein the risk assessment model comprises a gradient boosting machine (GBM) algorithm.

5. The method of claim 1, wherein receiving the first request comprises:
receiving an authentication request for access to the user account; and
determining the risk score in response to receiving the authentication request.

6. The method of claim 5, further comprising:
establishing a session for the user account with the identity management system in accordance with the response to the first request;
receiving, during the session, one or more second requests for the user account, the one or more second requests being associated with one or more second attributes;
determining, via the risk assessment model in response to the one or more second requests, a second risk score based at least in part on a second difference between the one or more second attributes and the pattern; and
responding to the one or more second requests based at least in part on whether the second risk score satisfies the threshold.

7. The method of claim 6, further comprising:
triggering a multi-factor authentication (MFA) request for the user account based at least in part on the second risk score satisfying the threshold, wherein the response to the one or more second requests are based at least in part on whether the MFA request is successful, wherein second request is an in-session request.

8. The method of claim 7, further comprising:
performing an adjustment to the pattern, wherein the adjustment is based at least in part on whether the MFA request is successful.

9. The method of claim 1, further comprising:
triggering a multi-factor authentication (MFA) request for the user account based at least in part on the risk score satisfying the threshold, wherein the response to the first request is based at least in part on whether the MFA request is successful, wherein the first request is a login request.

10. The method of claim 9, further comprising:
performing an adjustment to the pattern, wherein the adjustment is based at least in part on whether the MFA request is successful.

11. The method of claim 10, wherein risk scores associated with subsequent requests are based on the adjusted pattern.

12. The method of claim 1, wherein the one or more first attributes comprise an internet protocol (IP) address associated with a source of the first request, a type of device associated with the source of the first request, a browser associated with the source of the first request, an operating system of a device associated with the source of the first request, a geographic location associated with the source of the first request, an identifier of the device associated with the source of the first request, or a managed state of the device associated with the source of the first request, or any combination thereof.

13. The method of claim 1, further comprising:
obtaining at least one attribute of the plurality of attributes based at least in part on a data signal associated with one or more interactions between the user account and one or more applications associated with the identity management system.

14. The method of claim 1, further comprising:
obtaining at least one attribute of the plurality of attributes based at least in part on a data signal from an authenticator application of a device associated with the user account, wherein the authenticator application is associated with the identity management system.

15. An apparatus for assessing risk associated with users of an identity management system, comprising:
one or more memories storing processor-executable code; and
one or more processors coupled with the one or more memories and individually or collectively operable to execute the code to cause the apparatus to:
identify, via the one or more processors, a pattern associated with a user account of the identity management system, wherein the pattern is identified using at least a risk assessment model, and wherein the pattern is based at least in part on a plurality of attributes of the user account obtained at the identity management system over a duration;
receive, from a second device via an application programming interface, a first request for the user account, the first request being associated with one or more first attributes;
determine, via the one or more processors, a risk score based at least in part on a first difference between the one or more first attributes and the pattern; and
respond, via the one or more processors, to the first request based at least in part on whether the risk score satisfies a threshold.

16. The apparatus of claim 15, wherein the one or more processors are individually or collectively further operable to execute the code to cause the apparatus to:
train the risk assessment model to categorize requests into a first class associated with a first type of attribute or a second class associated with a second type of attribute, the second type of attribute being associated with lower risk than the first type of attribute.

17. The apparatus of claim 16, wherein, to train the risk assessment model, the one or more processors are individually or collectively operable to execute the code to cause the apparatus to:
input, to the risk assessment model, a first set of attributes of the plurality of attributes, the first set of attributes being associated with the first class; and
input, to the risk assessment model, a second set of attributes of the plurality of attributes, the second set of attributes being associated with the second class, wherein determining the risk score is based at least in part on one or more differences between the first set of attributes and the second set of attributes.

18. The apparatus of claim 16, wherein the risk assessment model comprises a gradient boosting machine (GBM) algorithm.

19. A non-transitory computer-readable medium storing code, the code comprising instructions executable by one or more processors to:
identify, at a first device of an identity management system, a pattern associated with a user account of the identity management system, wherein the pattern is identified using at least a risk assessment model, and wherein the pattern is based at least in part on a plurality of attributes of the user account obtained at the identity management system over a duration;
receive, from a second device via an application programming interface, a first request for the user account, the first request being associated with one or more first attributes;
determine, at the first device using the risk assessment model, a risk score based at least in part on a first difference between the one or more first attributes and the pattern; and
respond to the first request based at least in part on whether the risk score satisfies a threshold.

20. The non-transitory computer-readable medium of claim 19, wherein the instructions to receive the first request are executable by the one or more processors to:
receive an authentication request for access to the user account; and
determine the risk score in response to receiving the authentication request.
